(19) United States
(12) Patent Application Publication
(10) Pub. No.: US 2026/0240357 A1
(43) Pub. Date: Aug. 20, 2026

(54) AUTOMATIC POWDER AND LIQUID DISPENSING APPARATUS WITH MIXING CAPABILITIES, AND METHOD FOR MAKING AND USING THE SAME

(71) Applicant: BABY BREZZA INTERPRISES, LLC, Newark, NJ (US)

(72) Inventors: JASON ROONEY, Staten Island, NY (US); KEITH BROWN, Andover, NJ (US)

(21) Appl. No.: 19/056,543

(22) Filed: Feb. 18, 2025

(51) Int. Cl. A47J 31/40

(52) U.S. Cl. CPC A47J 31/401

(57) ABSTRACT

Powder and liquid dispensing and mixing apparatus and method for using the same can be provided. The powder and liquid dispensing and mixing apparatus can comprise a base unit and a cup with a motorized mixer. The base unit can be configured to dispense the powder into the cup, dispense the liquid into the cup, and transmit a wireless mixing control signal to the cup. The cup can be configured to receive the wireless control signal, and mix the powder and the liquid based on information providing in the received mixing control signal.

### FIELD OF THE DISCLOSURE

The present disclosure relates to an automatic powder and liquid dispenser with capabilities of mixing powder and liquid, and a method for making and/or using the same.

### BACKGROUND INFORMATION

Smoothies and shakes made from mixing a powder with a liquid, such as water, are a common form of supplementing dietary needs. While these powder-based drinks offer convenience over traditional meals in the form of time savings and mobility (e.g., drinking-on-the-go), there are drawbacks to a conventional use. For example, protein powders and other similar powders often come in large tubs or bags, sometimes weighing 10 pounds or more. Storing these tubs or bags in a location that is easily accessible for daily consumption can be a challenge. Moreover, moving theses powders from storage to a counter for use can be cumbersome, and risks spilling.

In addition to the logistical issues of storage and access presented by these powders, there are also issues with use of the powders. A primary challenge is mixing the powder in liquid. Manufacturers attempt to design their powders to create an end result that is pleasing to a majority of consumers. This can mean that producing a specific consistency of the product once mixed with a liquid. The amount of powder, the amount of liquid, and the type of liquid used are all variables effecting the consistency of the final product. As more liquid is used for a given amount of powder, the resulting shake transitions from a thicker consistency to a thinner consistency. As more powder is used for a given volume of liquid, the shake transitions from a thinner consistency to a thicker consistency. Differing liquids, such as water and milk, also have an effect on the consistency.

Manufacturers attempt to balance these variables, and the end result is powders with varying degrees of mixability. A primary challenge in the shake powder industry is the elimination of dry clumps (i.e. unmixed portions of powder) in a mixed shake. In addition to the powder manufacturers'attempt to design mixable powders that minimize or reduce clumping, there is a shaker cup industry that seeks to help with mixing powder with liquid that reduces or minimizes clumping. Shaker cups generally have different cup shapes designed to assist with reducing and breaking up clumps. Some shaker cups include mixing balls, other devices provide metal whisks in various shapes, etc. inside the cup that are intended to assist with the break-up clumps as a user shakes the cup with the powder and liquid inside. Still other attempts to solve the powder clumping include providing powered mixers that act like miniature blenders.

Each of these approaches have varying levels of success, but each has one or more drawbacks. For example, shaker cups usually have issues with a removal of clumps. Shaker cups with internal mixing elements do a better job of breaking down clumps, but the internal elements must be cleaned, which can be cumbersome, and stored which can be cluttering. Over time, these elements are often lost or broken, and users often throw them away because they end up being a more trouble than the benefit they provide. Powered mixers do a better job of removing clumps, but they require power and sometimes have a separate base element that remains in a fixed location such as the kitchen. These factors can each reduce the utility of these types of designs.

Thus, it may be beneficial to provide exemplary powder dispenser(s) and mixer(s), including methods associated therewith which can automatically dispense a metered amount of powder and liquid, and then mix that metered powder and liquid mixture to remove clumps, thereby addressing at least some of the deficiencies of existing devices.

### SUMMARY OF EXEMPLARY EMBODIMENTS

To address at least some of such deficiencies and/or issues, exemplary methods and apparatuses according to certain exemplary embodiments of the present disclosure can be provided which can be directed and/or associated with a configuration (e.g., an automatic apparatus for dispensing and mixing a powder and a liquid) that can comprise a base unit and a cup with a motorized mixer. The base unit can be configured to dispense the powder into the cup, dispense the liquid into the cup, and send a wireless mixing control signal to the cup. The cup can be configured to receive the wireless mixing control signal and mix the powder and the liquid in response to the received wireless mixing control signal. The wireless mixing function command can be transmitted via one of Bluetooth, Wi-Fi, or near field communication. The apparatus can include a dispensing funnel for dispensing each of the powder and the liquid. The dispensing funnel can be divided into two segments (although it can be more than two), e.g., one segment for the dispensing powder, and one for dispensing the liquid. In some exemplary embodiments of the present disclosure, the cup can include a power button for manually activated motorized mixing. The apparatus may also include a drip tray, and that drip tray can include one of inductive-or contact-based charging for a rechargeable battery in the cup.

According to further exemplary embodiments of the present disclosure, the apparatus can include a segmented metering wheel, which can be rotated by an electric motor, and can control the amount of powder being dispensed. The segmented metering wheel can control the amount of powder dispensed by forcing powder out of a dispensing hole in a powder container as the segmented metering wheel rotates. Furthermore, a scraper, attached to a powder container lid can assist in forcing the powder out of the dispensing hole as the segmented metering wheel rotates. The powder container lid can also include at least one finger (or an extension) protruding into the powder container and sifting the powder as it is moved by the rotating segmented metering wheel. The apparatus can include an integrated liquid tank to hold the liquid to be dispensed.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a front view of a powder and liquid dispenser and mixer according to an exemplary embodiment of the present disclosure;

FIG. 2 is a side view of the powder and liquid dispenser and mixer according to an exemplary embodiment of the present disclosure shown in FIG. 1;

FIG. 3A is a perspective view of a powder and liquid dispenser and mixer with a cut away at the powder container according to an exemplary embodiment of the present disclosure;

FIG. 3B is a perspective view of the powder and liquid dispenser and mixer as shown in FIG. 1 with the cut away at the powder container and also with the cup removed from the base unit according to an exemplary embodiment of the present disclosure;

FIGS. 4A and 4B are exploded perspective views of the powder container as shown in FIG. 1 assembly for use in the powder and liquid dispenser and mixer according to an exemplary embodiment of the present disclosure;

FIG. 4C is a front view of a powder container assembly of the powder container for use in the powder and liquid dispenser and mixer that is shown in FIG. 1 according to an exemplary embodiment of the present disclosure;

FIG. 5A is an exploded perspective view of a dispensing funnel assembly for use in a powder and liquid dispenser and mixer according to an exemplary embodiment of the present disclosure;

FIG. 5B is a perspective view of the dispensing funnel assembly for use in the powder and liquid dispenser and mixer as shown in FIG. 1 according to an exemplary embodiment of the present disclosure;

FIG. 5C is a cross section view of the dispensing funnel assembly for use in the powder and liquid dispenser and mixer as shown in FIG. 1 according to an exemplary embodiment of the present disclosure;

FIG. 6A is a perspective view of a mixing cup assembly for use with the powder and liquid dispenser and mixer as shown in FIG. 1 according to an exemplary embodiment of the present disclosure;

FIG. 6B is a front view of the mixing cup assembly as shown in FIG. 6A according to an exemplary embodiment of the present disclosure;

FIG. 6C is an exploded perspective view of the mixing cup assembly as shown in FIG. 6A according to an exemplary embodiment of the present disclosure;

FIG. 7 is a side cross-sectional view of the powder and liquid dispenser and mixer according as shown in FIG. 1 to an exemplary embodiment of the present disclosure;

FIG. 8 is a flow chart illustrating an exemplary method for using the powder and liquid dispenser and mixer according to an exemplary embodiment of the present disclosure; and

FIG. 9 is a flow chart showing an exemplary method for using the powder and liquid dispenser and mixer according to another exemplary embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different aspects of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

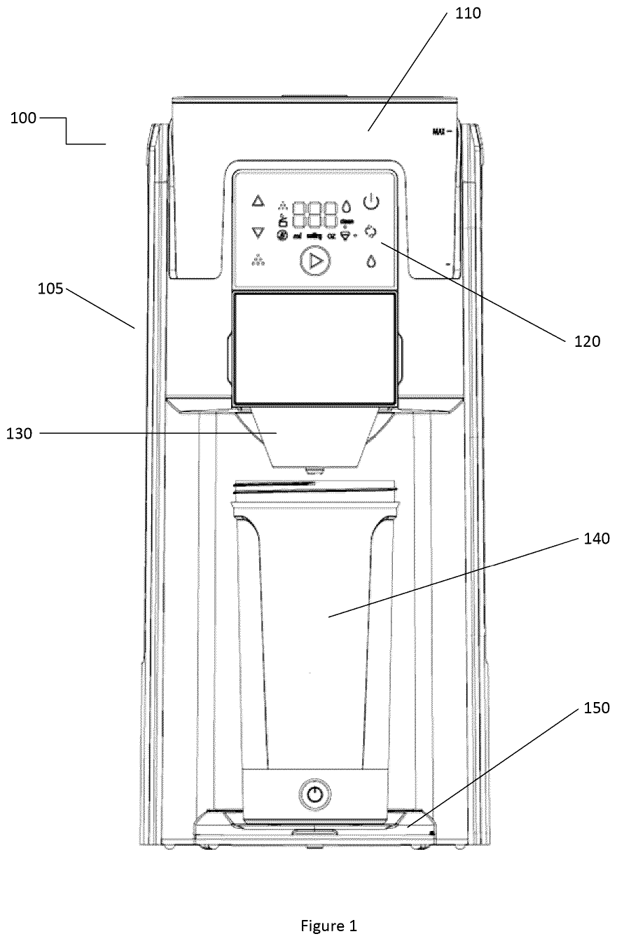

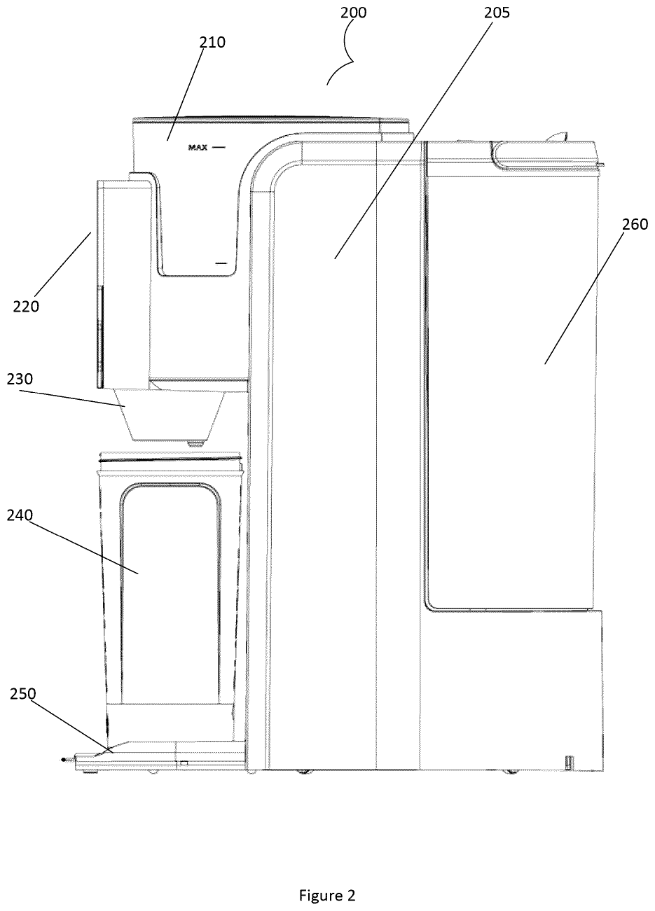

FIG. 1 shows a front view of an exemplary embodiment of an electrical appliance according to the present disclosure, configured to dispense water and powder (e.g., protein powder) into a mixing cup, e.g., an automatic powder and liquid dispenser. For ease of reference herein, the overall machine/system can be referred to as “Supermix,” but limited thereto. Supermix 100 can include a number of discrete components and features. For example, Supermix 100 can include body 105. Powder container 110 can be attached to body 105 proximal to a top side of body 105. As illustrated in FIG. 1, while powder container 110 is attached to a top side of body 105, it can be integrated into Supermix 100 in such a way as to largely visible from the front (and side) of Supermix 100. Powder container 110 can house a defined amount of any powder intended for mixing with a liquid by Supermix 100. For example, powder container 110 can house protein powder, creatine, collagen peptides, greens powders, etc. Supermix 100 can also include a liquid tank (not shown) as illustrated in FIG. 2 and as described below.

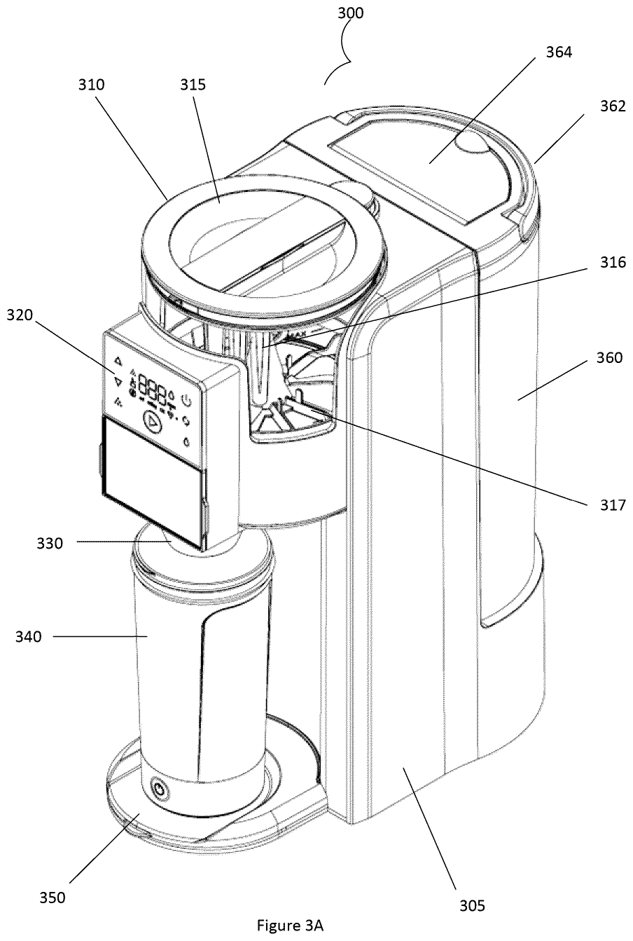

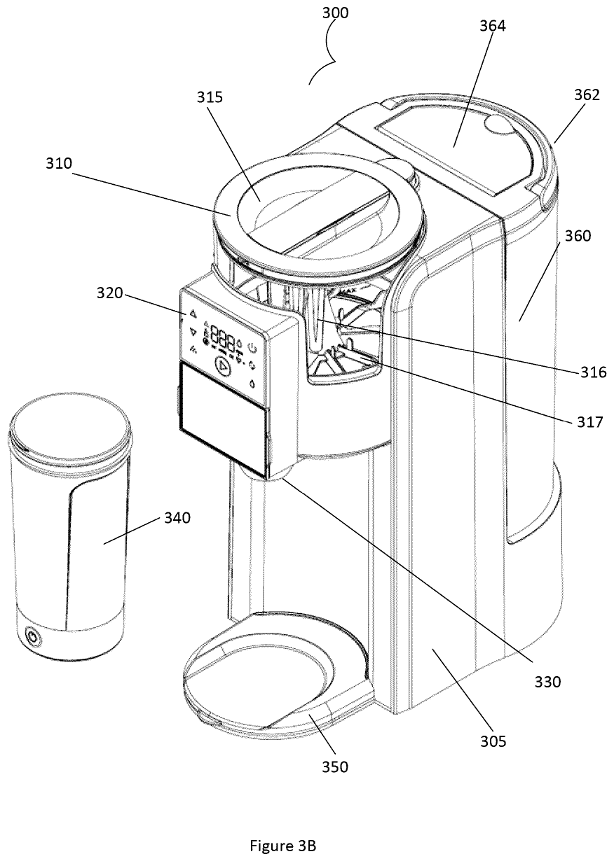

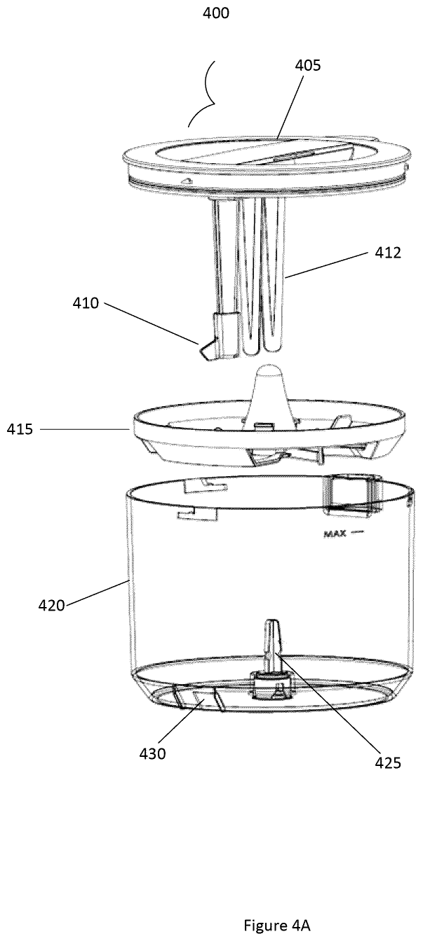

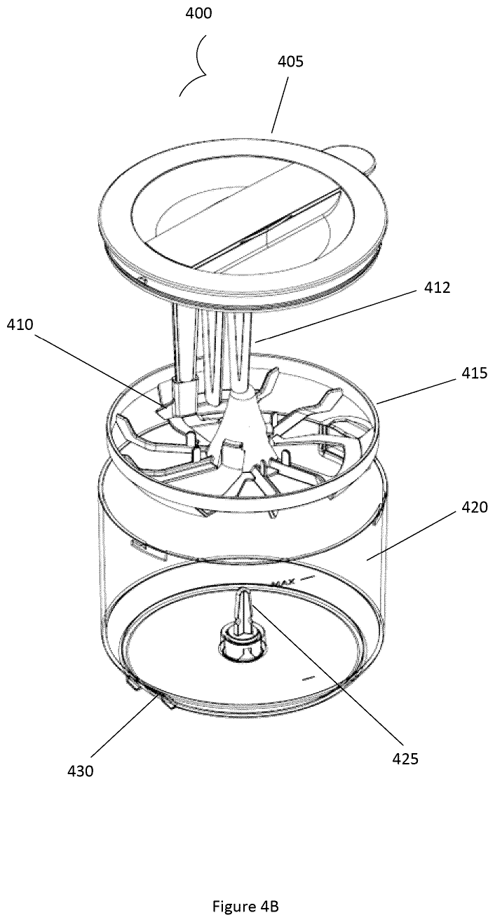

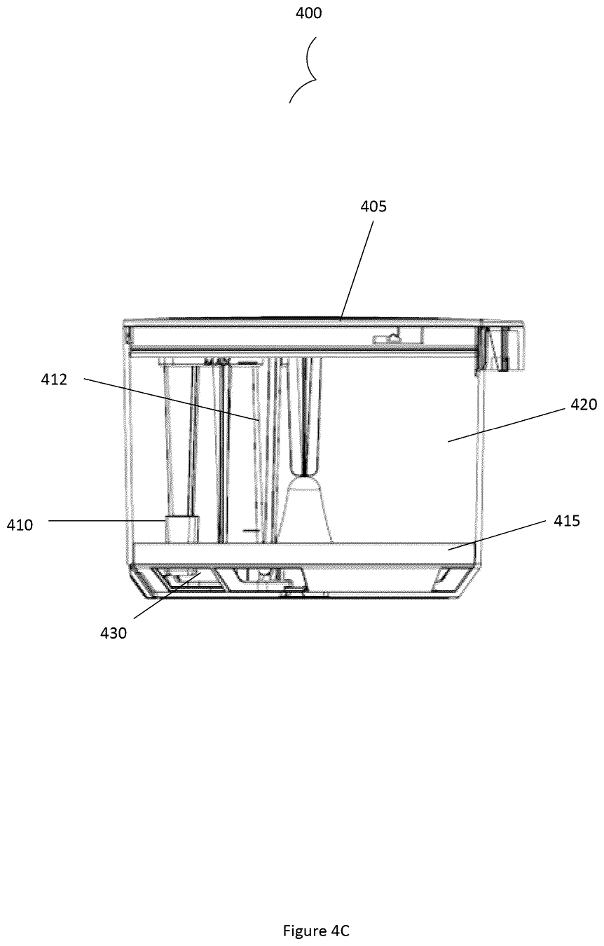

Powder container 110 can be transparent or partially transparent to facilitate a user to see a powder level in powder container 110 without necessitating removal from base 105. Powder container 110 can include markings and/or visible indicators on external and/or internal tank surfaces. For example, powder container 110 can include max fill and/or refill/min fill lines on a container surface that can be viewed by a user in reference to a powder level within the container, much like measuring cups used in cooking/baking. Details pertaining to the inside of powder container 110, as well as its function, are described below with respect to FIGS. 3 and 4.

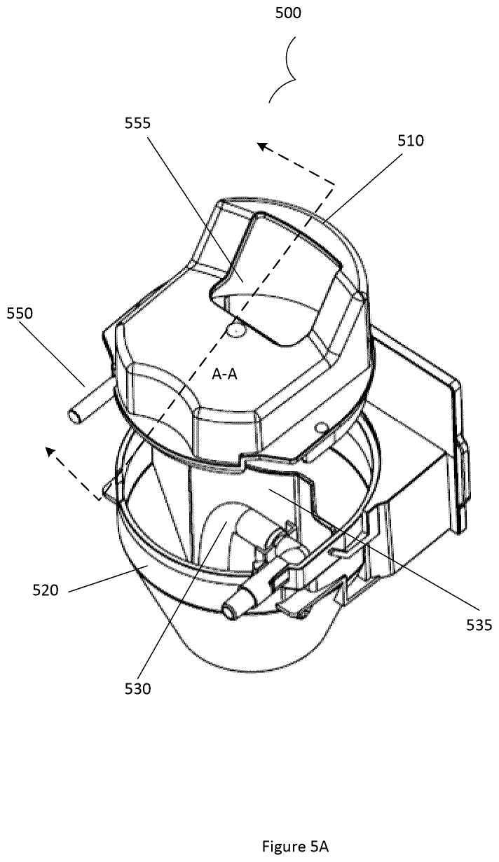

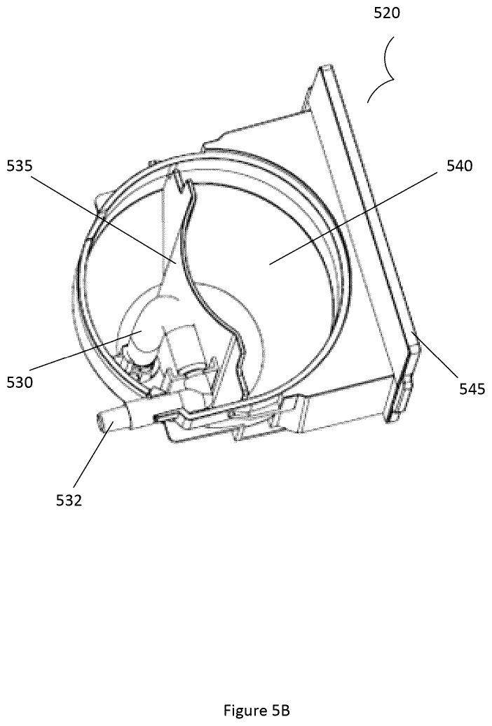

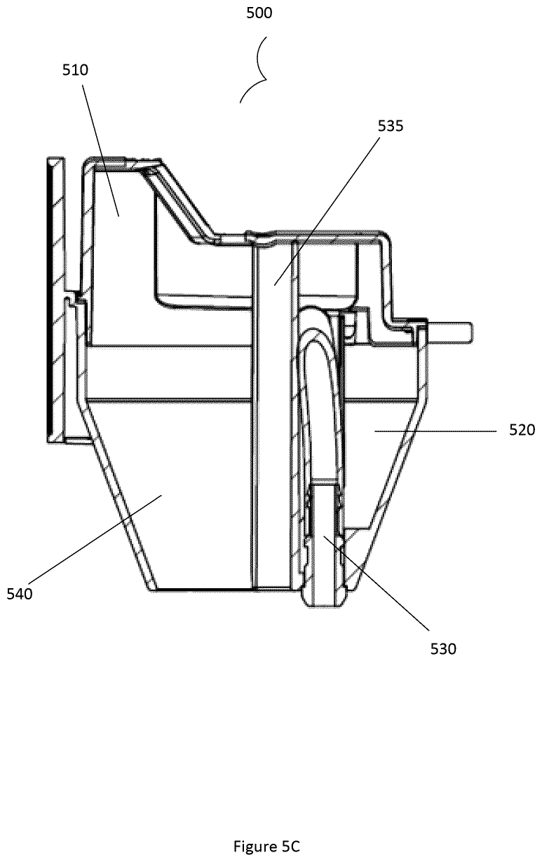

Supermix 100 can include control panel 120 integrated into body 105. Control panel 120 can have various functions such as power on/off, auto-mix, liquid dispense, powder dispense, increase/decrease, start/pause, etc. Control panel 120 can be or include a backlit LCD panel with multiple various functions. For example, control panel 120 can include a power button for turning Supermix on and off. The power button can be backlit in either the on or off status, while the remaining buttons and panel displays may be backlit only when Supermix 100 is in the on condition. Supermix 100 can have the ability to alert a user to various faults and conditions on control panel 120. For example, control panel 120 can indicate when a part is not installed correctly or when a liquid or powder amount is insufficient. Supermix 100 can also include dispensing funnel 130. This funnel can dispense both powder from powder container 110 and liquid from the liquid tank simultaneously. As shown in FIGS. 5A-5C and provided in the related description below, dispensing funnel 130 can keep powder and liquid separated during dispensing within dispensing funnel 130. This can eliminate caking/globing within dispensing funnel 130, and can greatly reduce or eliminate the need for cleaning.

Mixing cup 140 can be part of Supermix 100 and can be both motorized and rechargeable. While mixing cup 140 can include power button, e.g., on the base, mixing cup 140 can be in communication with Supermix 100 and can automatically turn on based on a signal from Supermix 100. Communication can be via, Bluetooth, NFC, WI-FI, or any other suitable communication protocol. Mixing cup 140 can be turned on by Supermix 100 at specific times, for specific intervals, and at specific power levels in order to accomplish a programmed mixing sequence that can maximize mixing and minimize powder clumps in the shake. For example, Supermix 100 can turn on mixing while dispensing of water and powder are still ongoing. Supermix 100 can also stop dispensing at any point, begin mixing, then resume dispensing. Any combination of dispensing and mixing is possible. The mixing sequence can be pre-programmed, and can also be user-adjustable based on preference, water to powder ratio, type of powder, etc.

Drip tray 150 can be configured to attach to body 105 at or near a bottom surface as illustrated in FIG. 1. Drip tray 150 can be configured to hold and center mixing cup 140 securely to avoid tipping and to ensure dispensed liquid and powder enter mixing cup 140. Drip tray 150 can also be configured to contain any potential spills, and can be removable from base 105 for easy cleaning. In some exemplary embodiments of the present disclosure, drip tray 150 can have inductive charging capabilities to charge a rechargeable battery in the base of mixing cup 140. In other exemplary embodiments of the present disclosure, drip tray 150 can have metal contacts that are configured to engage with contacts on mixing cup 140 for charging.

FIG. 2 shows a side view of an exemplary embodiment of Supermix 200 according to the present disclosure. Supermix 200 can include body 205, powder container 210, control panel 220, dispensing funnel 230, motorized mixing cup 240, drip tray 250. These elements can be similar to those described with respect to FIG. 1 above. Additionally, Supermix 200 can include removable liquid tank 260 installed in the rear of body 205. Liquid tank 260 can be sized to accommodate a set liquid volume. For example, the tank may be sized to provide enough liquid for a set number of mixed shakes. In some exemplary embodiments of the present disclosure, the tank size can be dictated by the overall dimensions of Supermix 260. In some exemplary embodiments of the present disclosure, liquid tank 260 can be actively cooled. Active cooling not only facilitates a user to set a preferred temperature for his or her shake, and it can also expand the menu of liquids compatible with Supermix 200. For example, milk should be maintained at a cooled temperature or it will quickly spoil. Active cooling allows for use of Supermix 200 with milk, as well as any other liquid that needs to be maintained at a certain temperature. Active cooling can be accomplished through refrigeration, thermoelectric technology, etc. In some exemplary embodiments of the present disclosure, the size of liquid tank 260 may be configured based on cooling capabilities of an active cooling system.

In some exemplary embodiments of the present disclosure, Supermix 200 can include active heating. The liquid in liquid tank 260 can be heated in tank 260 or elsewhere within Supermix 200 prior to dispensing. Active heating can make Supermix 200 suitable for additional uses such as making hot chocolate. Active heating and active cooling may not be mutually exclusive in various exemplary embodiments of the present disclosure.

Liquid tank 260 can be transparent or partially transparent to facilitate a user to see a liquid level in liquid tank 260 without necessitating removal from base 205. Liquid tank 260 can include markings and/or visible indicators on external and/or internal tank surfaces. For example, liquid tank 260 can include max fill and/or refill/min fill lines on a tank surface that can be viewed by a user in reference to a liquid level within the tank, much like measuring cups used in cooking/baking. Liquid tank 260 can also include other indicators such as US and/or metric indicators at various liquid volumes.

In some exemplary embodiments of the present disclosure, Supermix 200 can be plumbed with a water supply, similar to an ice maker on a refrigerator. In this exemplary embodiment, liquid tank 260 can include an automated system to fill liquid tank 260 and then discontinue water flow/supply once a certain liquid level is reached. For example, liquid tank 260 can include a valve controlled by a float configured to force the valve into a closed position as a liquid in liquid tank 260 causes the float to rise.

FIGS. 3A and 3B provide a perspective view of Supermix 300 with a cut away at the powder container 310. FIGS. 3A and 3B further illustrate the features of the exemplary apparatus illustrated in FIGS. 1 and 2. For example, FIGS. 3A and 3B show Supermix 300 with body 305, powder container 310 (partially), control panel 320, dispensing funnel 330, motorized mixing cup 340, drip tray 350, and liquid tank 360.

FIGS. 3A and 3B show that in some exemplary embodiments of the present disclosure, liquid tank 360 can also include a handle 362 integrated into the top of the tank. This handle 362 can pivot such that the handle 362 can be rotated flush with a top surface of liquid tank 360 while the tank is installed in Supermix 300. The handle 362 can be rotated upward to a usable position to aid in removing liquid tank 360 from Supermix 300. Furthermore, liquid tank 360 can also include a lid/door 364 integrated into a top surface of liquid tank 360. Lid/door 364 can swing between an open and a closed position. The open position can be utilized for filing liquid tank 360 without removing it from base 305. Once filled, lid/door 364 can be pivoted to the closed position to prevent contamination of the liquid inside liquid tank 360. Lid/door 364 can include a way for a user to move the lid/door 364 between open and closed positions. For example, lid/door 364 can include a thumb tab, as illustrated in FIGS. 3A and 3B. Alternative exemplary designs are also possible, such as a handle, a pull, a spring-loaded button release, etc.

FIGS. 3A and 3B further show that mixing cup 140 is removable from the rest of Supermix 300. As illustrated in FIG. 3A, mixing cup 140 can be located under dispensing funnel 330 with the guidance of drip tray 350. FIG. 3B shows that mixing cup 140 is removed from the rest of Supermix 300. After a powder and liquid has been dispensed and mixed, a user can remove mixing cup 140 from Supermix 300, and consume the contents. A user can also press the power button on mixing cup 140 to continue motorized mixing, because mixing cup 140 can be controlled manually apart from Supermix 300 and any preprogrammed mixing procedures. While a single mixing cup 140 is shown in conjunction with Supermix 300 in FIG. 3B, additional mixing cups 400 can be used/associated. This can reduce or eliminate the need to clean a single mixing cup prior to each time Supermix 300 is used.

Powder container 310 can include lid 315. Lid 315 can be attached to powder container 310 in a variety of ways such as screw-on, slide fit, slide-fit with gasket for sealing, etc. Lid 315 can include an integrated handle. For example, lid 315 can include an integral cross-member that can be grasped by hand to apply a rotational and/or axial force for removal from powder container 310. In some exemplary embodiments of the present disclosure, other handles can be used such as the handle described with respect to liquid tank 360, or any other suitable handle design. In some exemplary embodiments of the present disclosure, lid 315 can be keyed and/or provided such that it engages powder container 310 in only a single orientation to ensure correct and complete assembly. In some exemplary embodiments of the present disclosure, lid 315 can positively connect to/lock with powder container 310.

The cut away in powder container 310 as shown in FIGS. 3A and 3B reveals certain exemplary internal features. For example, powder container 310 can include a metering wheel 317. Metering wheel 317 can be configured to rotate during the powder dispensing operation. As described in detail below with respect to FIGS. 4A-4C, metering wheel 317 can act to dispense powder from powder container 310. Additionally, the internal side of lid 315 can include one or more fingers 316 (or extensions) that can protrude from an inner surface of lid 315. These fingers can extend into the internal volume of powder container 310. As metering wheel 317 turns, fingers 316 can sift he powder, thereby reducing any clumps that may exist in the dry powder inside powder container 310.

FIGS. 4A and 4B show exploded views of the powder container, with FIG. 4A illustrating a front view, and FIG. 4B illustrating a perspective view. Lid 405 can seal the powder container 400, and when installed, can form a top surface of powder container 400. An outer surface of lid 405 can include a handle for gripping/twisting/pulling lid 405. The handle can be an integral cross member in the top surface or some other handle, as described above with respect to FIGS. 3A and 3B. Fingers 412 can attach to (or molded with) and extend from an inner surface of lid 405. Scraper 410 can also attach to (or molded with) and extend from an inner surface of lid 405.

Container body 420, together with lid 405, can form the external shape of powder container 400. Container body 420 can also accommodate metering wheel 415, as well as fingers 412 and scraper 410 in the internal volume created by the combination of container body 420 and lid 405. Container body 420 can include powder dispensing hole 430 on a lower surface. For example, dispensing hole 430 can be provided on or in a chamfered surface between a bottom surface and a side wall of container body 420. Further, axle 425 integrated into and centered within a bottom surface of container body 420. Axle 425 can be configured to interface with and turn metering wheel 415 when driven by the drive gear of a gearbox, powered by an electric motor. Container body 420 can include maximum and/or minimum powder fill lines on a side wall/surface as a filling guide for users and to alert users as to when powder container 400 should be refilled.

FIG. 4C shows the relative orientation of fingers 412, scraper 410, metering wheel 415, and dispensing hole 430 when in the installed position defined by the installation of lid 405 onto container body 420.

### Exemplary Operation of Dispensing Container

A powder of choice can be added to powder container 400, up to a fill line that can be included on the outside of container body 420 (which may be transparent or semi-transparent). Lid 405 can be installed to container body 420 to seal the powder added to the inside volume of powder container 400 and to prevent contamination. The lid 420 may be keyed to connect to container body 420 in a single specific orientation. This can allow for scraper 410 to be oriented adjacent to dispensing hole 430.

When a call or a request is made by Supermix to dispense powder, an electric motor turns axle 425 via a drive gear, which in turn causes rotation of metering wheel 415. Metering wheel 415 includes a plurality of vertical ribs at designated intervals. These vertical ribs, in conjunction with the bottom surface of container body 420, result in multiple sections having defined specific volumes. Accordingly, specific, metered amounts of powder sit within these defined specific volumes. As metering wheel 415 rotates, it moves the metered amounts of powder within the volumes defined by the vertical ribs of the metering wheel 415. As a metered amount of powder rotates toward the dispensing hole 430, the powder is forced through dispensing hole 430 by adjacent scraper 410 and out of powder container 415. Dispensed powder then travels through the dispensing funnel of Supermix.

The amount of dispensed powder can be determined by the amount of rotation of metering when 415, and therefor the number of defined wheel sections forced past dispensing hole 430. As the wheel rotates, causing relative motion of the powder inside powder container 400, stationary fingers 412 can serve to sift and/or rake the powder, thereby breaking any clumps and ensuring a uniform powder (and therefore uniform metering by the metering wheel 415).

FIG. 5A shows an exploded perspective view of a dispensing funnel 500. Dispensing funnel 500 can include cover 510 that connects to funnel base 520. Funnel base 520 can include an internal divider wall 535 that may divide the internal volume of dispensing funnel 500. Divider wall 535 is further shown in FIG. 5B which is a perspective view of funnel 500 without cover 510. The divider wall 535 can create two separate internal volumes within dispensing funnel 500, one for dispensing powder and one for dispensing liquid. Dispensed liquid and powder can be kept separate to reduce unintended mixing within dispensing funnel 500, which can lead to globs, clumps, dispensing blockages, unsanitary conditions, etc. While divider wall 535 is depicted in FIGS. 5A and 5B with specific geometry (curved to favor the volume of the powder dispensing volume over the liquid dispensing volume), it should be appreciated that other geometries and design goals may be implemented in divider wall 535.

The geometry of both cover 510 and funnel base 520 may be such that the cover 510 can only mate with funnel base 520 in a single orientation. That single orientation can result in window 555 of cover 510 being oriented above the funnel volume specifically for dispensing powder. Window 555 can also be directly below the dispensing hole 430. Window 555 can be configured to substantially exist within a chamfered surface of cover 510, and that chamfered surface can be designed to match the chamfered surface of powder container 400 where dispensing hole 430 exists. When dispensing funnel 500 is in an installed state, powder from dispensing hole 430 of powder container 400 can fall directly and necessarily through window 555 into the funnel volume for powder dispensing.

The funnel volume for liquid dispensing can include liquid tube 530. Liquid tube can be rigidly mounted to funnel base 520 and be substantially centered in the defined funnel volume to minimize splatter and the possibility that any internal surface of funnel based 520 becoming wet and/or contaminated. Liquid tube 530 can also be partially integrated into divider wall 535 as shown in FIG. 5B. The specific size, routing, and orientation of liquid tube 530 may be changed and/or configured/optimized based on design goals.

Dispensing funnel 500 can be removable for cleaning, servicing, etc. Accordingly, liquid tube 530 can include a fitting that may disconnect from the Supermix device and automatically reattach upon installation of dispensing funnel 500 into the Supermix device. Funnel base 520 can include tracks, guides, or the like for guiding dispensing funnel 500 into the correct orientation as it is installed into the Supermix device. This can ensure relative positioning of all components and also ensure the correct connection of liquid tube 530. Cover 510 may include tab 550 that may also serve as a guide for installation of dispensing funnel 500 and also insure correct and full installation of cover 510 to funnel base 520.

FIG. 5C shows a section view of dispensing funnel 500. Cover 510 is shown mated to funnel base 520. Divider wall 535 is shown internal to funnel base 520, thereby creating two internal funnel volumes. Powder dispensing volume 540 is a relatively larger area that allows powder to pass through unobstructed, but funnels towards the bottom outlet so that dispensed powder can be directed into a specific target (e.g., the opening of a mixing cup). Liquid dispensing volume 520 can be the remaining internal volume defined by the funnel base 520 and divider wall 535. Liquid dispensing volume 520 can include liquid tube 530. As shown in FIG. 5C, liquid tube 530 can extend past the bottom opening of funnel base 520. In other exemplary embodiments of the present disclosure, the orientation of liquid tube 520 can be different.

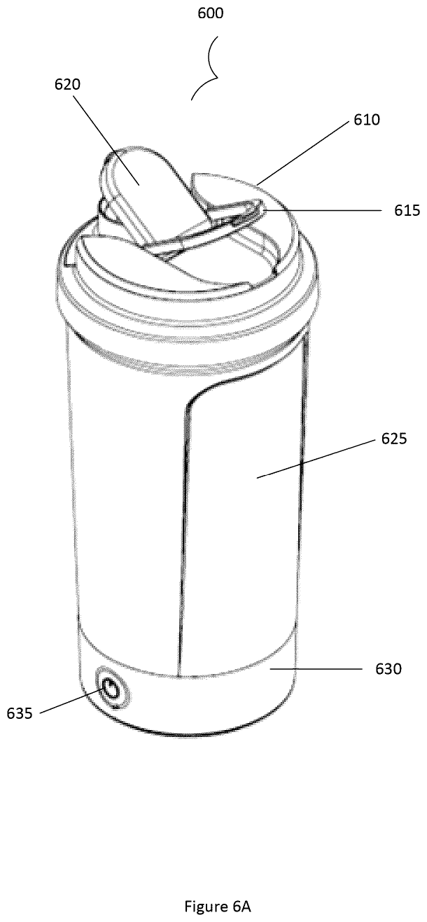

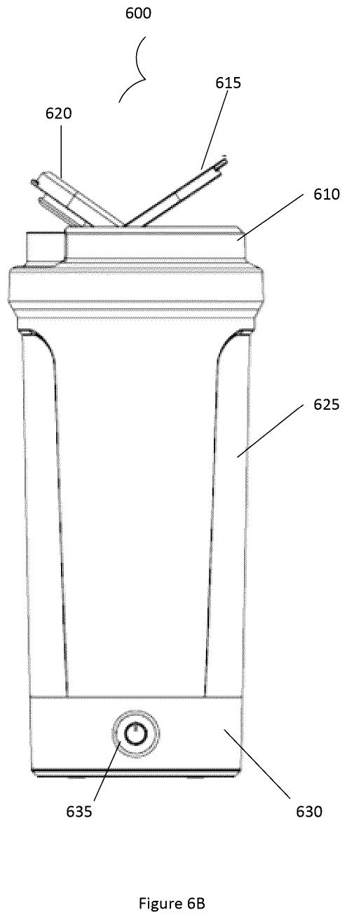

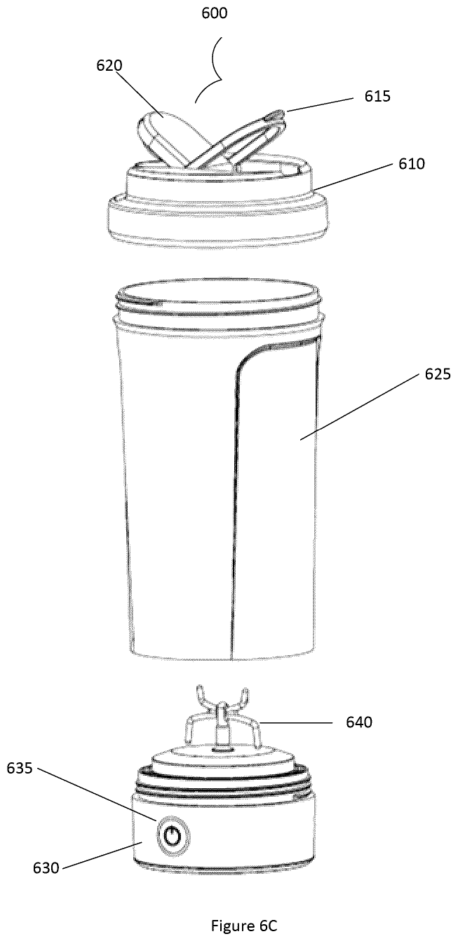

FIG. 6A-6C illustrate different views of mixing cup 600. For example, FIG. 6A shows a perspective view of mixing cup 600, FIG. 6B shows a front view, and FIG. 6C shows an exploded view. Mixing cup 600 can comprise a mixing cup body 625, a lid 610, and a base 630. Lid 610 can include handle 615 and spout 620. The handle 615 is shown as a loop that pivots to be flush with the lid when not in use, but other designs are possible. Further, spout 620 can include a closeable cover to prevent spilling. Base 630 can include a power button 635 for manual operation of the powered mixing function of mixing cup 600. As shown in FIG. 6C, base 630 can include a mixing wand 640 that extends into the internal volume of body 635 when base 630 is connected to body 635. Base 630 can be connected to body 625 via male/female threads or any other suitable means of attachment. Mixing wand 640 can be attached to a mixing motor that can be internal to base 630. Circuitry for communications between mixing cup 600 and the Supermix device (for running mixing programs as described above), can be located in base 630.

As noted above, pressing power button 635 can result in manual operation of the powered mixing function of mixing cup 600. For example, pressing the button may toggle on and off the mixing wand 640. Further, button 635 can be programmed for specific functions. For example, in an exemplary embodiment of the present disclosure, pressing button 635 once can result in a 25 second mix cycle. An led light around power button 635 can indicate running of this cycle. Furthermore, a double press of power button 635 can result in a 50 second mix cycle. Again, an led light can indicate running of this cycle. The led light may turn a different color, e.g., red, to indicate a low battery power condition.

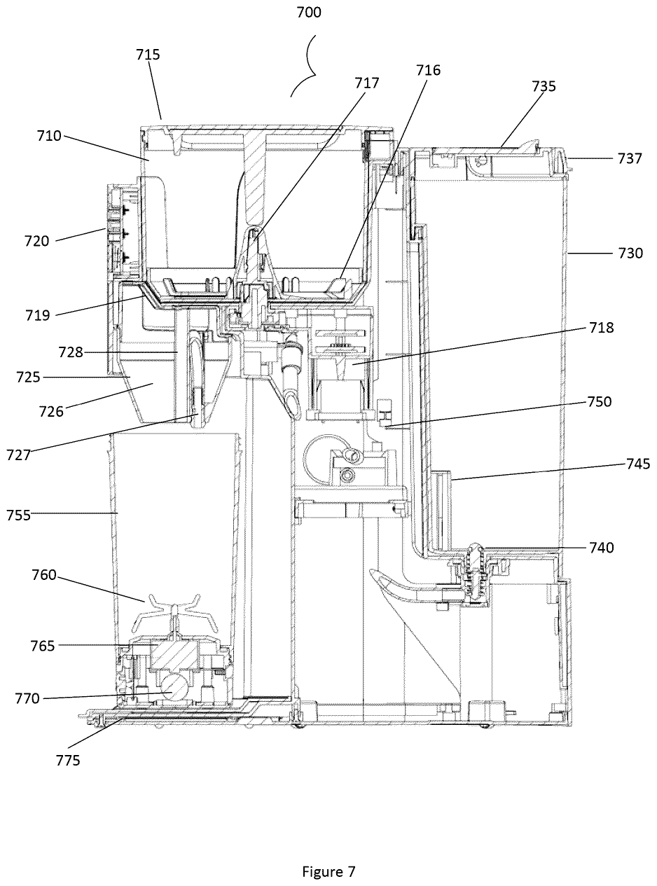

FIG. 7 shows a section view of Supermix 700, which includes powder container 710 and lid 715 for powder container 710. As shown in FIG. 7, axle 715 can turn metering wheel 716, powered by motor 718 through the attached gear set. Dispensing hole 719 is shown in an exemplary orientation relative to dispensing funnel 725. The powder can be segregated from the liquid by divider wall 728 into a separate internal volume 726 specifically for powder dispensing. The liquid may be supplied through dispensing funnel 725 via liquid tube 727. The powder and liquid can be dispensed directly into mixing cup 755. Mixing wand 760 can be used to stir/mix the powder and liquid together and to remove clumps. Inside the cup base can be motor 765 that turns mixing wand 760, and rechargeable battery 770 that powers motor 765 and also communications circuitry. Drip tray 775 and display panel 720 are also shown in FIG. 7.

Liquid tank 730 is shown in FIG. 7 with lid 735 having handle 737. Internal to Supermix 700 can be a liquid inlet valve 740 that can move liquid from liquid tank 730 through Supermix 700, and ultimately dispense the liquid from liquid tube 727 into mixing cup 755. The liquid can be moved through Supermix 700 by liquid pump and flow meter 750. Liquid level sensor 745 can monitor liquid levels in liquid tank 730 and can warn users when the tank needs to be refilled. This warning can be displayed on display panel 720. Water level sensor 745 can also be used to prevent a dispensing and mixing program where there is insufficient liquid in liquid tank 730.

### Exemplary Operating Sequence

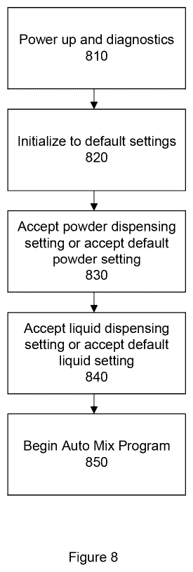

FIG. 8 shows a flow chart providing an exemplary operating sequence for the Supermix according to the exemplary embodiments of the present disclosure. For example, in procedure 810, power can be supplied to the Supermix device, in a preferred embodiment, this can be a power cord plugged into a residential power outlet. Once power is supplied to Supermix, a self-diagnostic test may run, and an audible beep can indicate a successful diagnostic. During the self-diagnostic test, the display panel may provide an indication that the test is running. For example, the display may fully light all functions/buttons or otherwise state that a test is running. In some exemplary embodiments of the present disclosure, supplying power may cause the display to illuminate a power button on the display. Upon a user pressing the power button, the Supermix may enter the self-diagnostic test.

In procedure 820, the Supermix display may default to set conditions. For example, a 12 oz (360 ml) default setting can be used/displayed along with a set amount of powder to be dispensed. In some exemplary embodiments of the present disclosure, Supermix can remember a previous setting and default to the previous setting. In some embodiments, Supermix may be capable of saving preferred settings that may be recalled by a user.

In procedure 830 the amount of powder to be dispensed can be adjusted if an amount different from the default amount is desired. For example, a user can press the powder dispensing button on the control panel. As a result, digits showing a powder setting can appear on a main display on the control panel, with (or without) the powder setting button (e.g., a dots icon) illuminated to indicate user selection. Pressing an “increase” button (e.g., an up arrow, a “+”, etc.) can cause the powder setting number to increase. Conversely, pressing the “decrease” button can cause the powder setting number to decrease. Powder setting number can correlate to a relative amount of powder that can be configured based on various design objectives. For example, in one embodiment, the powder setting numbers can range from e.g., 1-99.

In procedure 840, the amount of liquid to be dispensed can be adjusted if an amount different from the default amount is desired. For example, a user can press the liquid dispensing button on the control panel. As a result, digits showing a liquid dispensing amount can appear on a main display on the control panel, with (or without) the liquid setting button (e.g., a liquid drop icon) illuminated to indicate user selection. Pressing an “increase” button (e.g., an up arrow, a “+”, etc.) can cause the liquid dispensing amount to increase. Conversely, pressing the “decrease” button can cause the liquid dispensing amount to decrease. Liquid dispensing amounts can move in various steps. For example, a user may be able to move between ounces and/or fractions thereof. In some embodiments, there may be a minimum amount of liquid as well as a maximum amount so as to avoid overfilling the mixing cup. For example, in some exemplary embodiments of the present disclosure, the minimum can be 6 ounces, and the maximum can be 24. Other ranges can be used. Supermix can display liquid amounts in ounces as well as in ml.

In procedure 850, an auto mix program can be initiated when a user presses a start button on the control panel. This can start a program using the user-set powder and liquid amounts (if selected, or default amounts if not selected in steps 830 and 840). Supermix can dispense the powder and liquid in any sequence. For example, liquid may be dispensed first, then powder, or vice-versa. Also, the powder and liquid may be dispensed simultaneously, or they may be staged so that some of one is added, then some of the other, in any conceivable sequence or timing.

As described above, dispensing powder can be accomplished by activating a motor that turns an axle (through a gear set), to turn a metering wheel that moves powder past a dispensing hole in the powder container where the powder falls through a dispensing funnel into the mixing cup. For example, in one exemplary embodiment of the present disclosure, the powder motor can turn clockwise, then after completion of a dispensing sequence, the powder motor can stop e.g., 4 ms and can reverse turn e.g., 20 ms to go back a correct starting position. For example, to ensure that powder does not leak from the dispensing hole, the metering wheel must stop at a correct so as to block/close the dispensing hole.

Supermix, which is in communication with the mixing cup, can send a signal to begin mixing at any point within the dispensing sequence, or after dispensing is complete. Communication between the Supermix and the mixing cup can be through any communications protocols. For instance, in some exemplary embodiments of the present disclosure, the Supermix drip tray can have a copper coil and cause communication with the mixing cup via electromagnetic induction. In such exemplary embodiments, the copper coil in the drip tray of the supermix can transmit a signal to the cup to turn on and off the motor that turns the mixing wand in the cup. Other communication protocols are possible. The mixing can be for any duration, can be pulsed, etc. A sequence of dispensing and mixing may be configured to optimize the resulting shake. For example, an optimal shake may be one with minimal powder clumping, a desired amount of body/consistence, etc. A mix program can be different based on selected settings. For example, in one exemplary embodiment of the present disclosure, for powder settings 1-50, the mixing cup motor can run for e.g., 25 seconds and turn off automatically. For powder settings 51-99, the mixing cup motor can run for e.g., 50 seconds and turn off automatically.

In some exemplary embodiments of the present disclosure, an auto mix button can be pressed to turn on or off the mixing portion of the automate mix program. For example, when a user turns off the auto-mix function, subsequently pressing the start button may result in dispensing of powder and liquid, but without communication to the mixing cup for operating of the mixer in the mixing cup base. The auto mix button can turn a different color to indicate an auto mix program has been selected. Pressing the button again may return the button to the original color. In some embodiments the auto mix function can default to “on.” After running a cycle with the auto mix function “off,” Supermix may default back to the auto mix “on” condition.

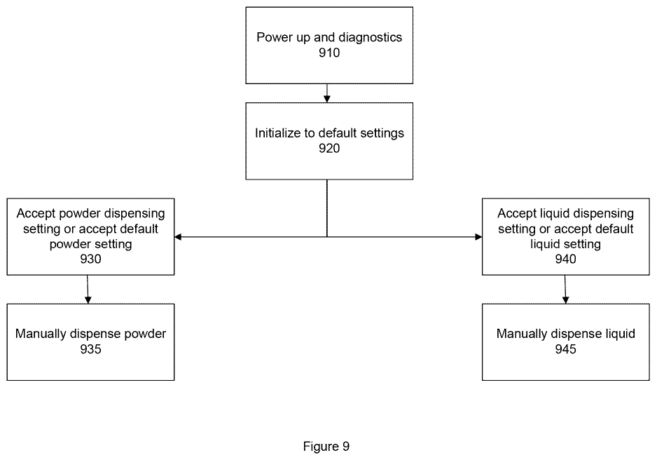

FIG. 9 shows a flow chart for an exemplary operating sequence where a user selects dispensing of only powder or only water according to an exemplary embodiment of the present disclosure. For example, in procedure 910, power can be supplied to the Supermix device, in an exemplary embodiment, this can be a power cord plugged into a residential power outlet. Once power is supplied to Supermix, a self-diagnostic test may run, and an audible beep can indicate a successful diagnostic. During the self-diagnostic test, the display panel may provide an indication that the test is running. For example, the display may fully light all functions/buttons or otherwise state that a test is running. In some exemplary embodiments of the present disclosure, supplying power may cause the display to illuminate a power button on the display. Upon a user pressing the power button, the Supermix may enter the self-diagnostic test.

In procedure 920, the Supermix display may default to set conditions. For example, a 12 oz (360 ml) default setting may be used/displayed along with a set amount of powder to be dispensed.

In procedure 930, the amount of powder to be dispensed can be adjusted if an amount different from the default amount is desired. For example, a user can press the powder dispensing button on the control panel. As a result, digits showing a powder setting can appear on a main display on the control panel, with (or without) the powder setting button (e.g., a dots icon) illuminated to indicate user selection. Pressing an “increase” button (e.g., an up arrow, a “+”, etc.) can cause the powder setting number to increase. Conversely, pressing the “decrease” button can cause the powder setting number to decrease. Powder setting number can correlate to a relative amount of powder that can be configured based on various design objectives. For example, in one embodiment, the powder setting numbers can range from e.g., 1-99.

In procedure 935, powder can be dispensed without liquid by pressing and holding the powder button for 3 seconds. The powder only function can be used in various situations, for example, including when a different liquid from that in the tank is desired, or when fine tuning an already dispensed mixture. The Supermix can default to a condition whereby the mixing bottle will turn on when dispensing only powder (e.g., to help with the fine tuning scenario discussed above). However, an auto-mix condition can be turned off by a user to prevent mixing in the scenario where powder is dispensed into a dry cup (e.g., for use with a liquid different from what is in the liquid tank). The auto mix button can turn a different color to indicate an auto mix program has been selected. Pressing the button again may turn off auto mix and return the button to the original color.

In procedure 940, the amount of liquid to be dispensed can be adjusted if an amount different from the default amount is desired. For example, a user can press the liquid dispensing button on the control panel. As a result, digits showing a liquid dispensing amount can appear on a main display on the control panel, with (or without) the liquid setting button (e.g., a liquid drop icon) illuminated to indicate user selection. Pressing an “increase” button (e.g., an up arrow, a “+”, etc.) can cause the liquid dispensing amount to increase. Conversely, pressing the “decrease” button can cause the liquid dispensing amount to decrease. Liquid dispensing amounts can move in various steps. For example, a user may be able to move between ounces and/or fractions thereof. In some embodiments, there may be a minimum amount of liquid as well as a maximum amount so as to avoid overfilling the mixing cup. For example, in some exemplary embodiments of the present disclosure, the minimum can be 6 ounces and the maximum can be, e.g., 24. Other ranges can be used. Supermix can display liquid amounts in ounces as well as in ml.

In procedure 945, liquid can be dispensed without powder by pressing and holding the liquid dispensing button for a number of seconds, e.g., 3 seconds. The liquid only function can be used in various situations, for example, including when a user only wants a cup of liquid from the tank, or when fine tuning an already dispensed mixture. The function of the auto-mix condition can be the same as described above with respect to procedure 935 for powder only dispensing.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A method for dispensing and mixing a powder and a liquid, comprising:
dispensing, from a dispensing apparatus, the powder into a cup that includes a motorized mixer;
dispensing, from the dispensing apparatus, the liquid into the cup; and
mixing the powder and the liquid in the cup by providing a mixing function command wirelessly from the dispensing apparatus to the cup.

2. The method of claim 1, wherein the powder and the liquid are dispensed from the apparatus through a dispensing funnel.

3. The method of claim 2, wherein the dispensing funnel includes at least two segments, one of the segments facilitates the dispensing of the powder, and another one of the segments facilitates the dispensing of the liquid.

4. The method of claim 1, wherein the cup includes a power button for manually activating an electronic motorized mixing.

5. The method of claim 1, further comprising charging a rechargeable battery in the cup through a charger integrated in a drip tray of the dispensing apparatus.

6. The method of claim 1, wherein an amount of the powder being dispensed is controlled by a segmented metering wheel turned by an electric motor.

7. The method of claim 6, wherein the segmented metering wheel forces the powder out of a dispensing hole in a powder container as the segmented metering wheel turns.

8. The method of claim 7, further comprising causing the powder to be forced out of the dispensing hole as the segmented metering wheel turns using a scraper which is attached to a powder container lid.

9. The method of claim 7, further comprising causing a sifting of the powder as it is moved by the rotating the segmented metering wheel using at least one finger or at least one extension that is attached to a powder container lid and which protrudes into the powder container.

10. The method of claim 1, wherein the dispensed liquid is stored in a liquid tank integrated into the dispensing apparatus.

11. The method of claim 1, wherein the wireless function command is transmitted via one of Bluetooth, Wi-Fi, or near field communication.

12. An apparatus for dispensing and mixing a powder and a liquid, comprising:
a base unit;
a cup including a motorized mixer,
wherein the base unit is configured to:
dispense the powder into the cup,
dispense the liquid into the cup, and
transmit a wireless control signal to the cup, and
wherein the cup is configured to:
receive the wireless control signal,
mix the powder and the liquid based on information provided in the received wireless control signal.

13. The apparatus of claim 12, wherein the powder and the liquid are dispensed from the apparatus through a dispensing funnel.

14. The apparatus of claim 13, wherein the dispensing funnel includes at least two segments, one of the segments facilitates the dispensing of the powder, and another one of the segments facilitates the dispensing of the liquid.

15. The apparatus of claim 12, wherein the cup includes a power button for manually activating an electronic motorized mixing.

16. The apparatus of claim 12, further comprising a drip tray that includes at least one of one of inductive-based charging configuration or a contact-based charging configuration for a rechargeable battery in the cup.

17. The apparatus of claim 12, further comprising a segmented metering wheel turned by an electric motor that controls an amount of the powder being dispensed.

18. The apparatus of claim 17, further comprising a powder container that includes a dispensing hole, wherein the segmented metering wheel forces the powder out of the dispensing hole as the segmented metering wheel turns.

19. The apparatus of claim 18, further comprising a scraper and a powder container lid which is attached to the scraper, wherein the scraper assists in forcing the powder out of the dispensing hole as the segmented metering wheel turns.

20. The apparatus of claim 18, further comprising at least one finger and a powder container lid which is attached to the at least one finger, wherein the at least one finger protrudes into the powder container and is configured to sift the powder as it is moved by the rotating segmented metering wheel.

21. The apparatus of claim 12, further comprising a liquid tank integrated into the apparatus, wherein the dispensed liquid is stored in the liquid tank.

22. The apparatus of claim 12, wherein the wireless function command is transmitted via one of Bluetooth, Wi-Fi, or near field communication.
